(19) United States
(12) Patent Application Publication
(10) Pub. No.: US 2009/0191040 A1
(43) Pub. Date: Jul. 30, 2009

(54) Handling Device

(76) Inventors: Ming-Hsun LIU, Taipei City (TW); Chung-Hsuan TSAI, Taipei City (TW)

Correspondence Address: Dr. BANGER SHIA, 102 Lindencrest Ct., Sugar Land, TX, 77479-5201, US

(21) Appl. No.: 12/418,546

(22) Filed: Apr. 3, 2009

Related U.S. Application Data
(63) Continuation-in-part of application No. 11/746,637, filed on May 9, 2007.

(51) Int. Cl. B25J 11/00; B66C 23/00; B25B 5/00

(52) U.S. Cl. 414/744.3

(57) ABSTRACT

A handling device and method utilizes a clamping arm that is screwed on a guide rod. The axial direction of the guide rod is in the vertical direction, and the rotating direction of the guide rod is in the horizontal direction. Makes the clamping arm rotate in the horizontal direction when the clamping arm is not restricted, and makes the clamping arm move in the vertical direction when the clamping arm is restricted. By such arrangements, the clamping arm can perform handling in the horizontal direction and in the vertical direction.

This application is a continuation of part of U.S. patent application Ser. No. 11/746,637, which claims the benefit of the earlier filing date of May 9, 2007. Claim 1 of this application is revised from the previous claim 1, claims 2, 3, 10 of this application correspond to the previous claims 2, 3 and 4 of the U.S. patent application Ser. No. 11/746,637, respectively, and claims 4-9 of this application are new.

### BACKGROUND OF THE INVENTION

1. Field of the Invention

The present invention relates to a handling device, and more particularly to a handling device that utilizes a clamping arm to move horizontally and vertically to perform handling operation.

2. Description of the Prior Art

In the automatic flow, handling is the most basic operation step and is used most widely. With the development of science and the micromation of technique, handling step is used more and more widely in many fields. For example, in the replication and production of optical discs, a disc handling device is a necessary mechanism for moving between different machines. However, a conventional disc handling device has to use complex connecting rod structure and control system to move discs in the horizontal direction or vertical direction. It is obvious that the more complicated structure of the conventional handling device is, the higher the failure rate brings, and maintenance fee consequently increases. Therefore a simple structure that can achieve the objective of handling goods is needed to improve the automatic technique.

Hence, many efforts have been made by the author of the application to further improve the existing technology, such as the “power source driven stand-up urinal” disclosed in U.S. Pat. No. 6,129,320, which is directed to aids for disabled persons and includes a guide rod on which are mounted two cylinders extending along the axial direction of the guide rod, and each of the cylinders has horizontal slots and a vertically extending gap. A nut provided with a swing arm is screwed on the guide rod, and the swing arm is able to extend out of the horizontal slots. When the vertical gaps of the two cylinders are aligned with each other, the guide rod can drive the swing arm to move within the vertical gaps. When the vertical gaps are misaligned, the guide rod drives the swing arm to move within the horizontal slots of the two cylinders. Such structure is able to drive the swing arm to move vertically or horizontally, so that disabled person can stand up by placing a hand on the swing arm for support. It is believed to play a certain role if this structure is applied to the handling technology.

After further analysis, however, we found that the displacement of the swing arm in radial direction is still restricted by the horizontal slots of the two cylinders, and the swing arm is consequently unable to rotate 360 degree. Furthermore, the positions of the vertical gaps of the two cylinders cannot be adjusted, hence, the axial displacement of the swing arm is restricted. Such a technology which is restricted both in radial and axial directions is inapplicable to handling device.

The present invention has arisen to mitigate and/or obviate the afore-described disadvantages.

### SUMMARY OF THE INVENTION

The primary objective of the present invention is to provide a handling device that utilizes a clamping arm to be screwed on a guide rod, and a C-shaped housing and a locking mechanism control the clamping arm to move in the horizontal direction and vertical direction, therefore achieving the objective of handling goods.

In order to achieve the abovementioned objectives, the handling device in accordance with the present invention comprises a guide rod, a clamping arm, a C-shaped housing and a locking mechanism. The guide rod is provided on its surface with an outer thread. The axial direction and the rotation direction of the guide rod are vertical to and intersect each other. The axial direction of the guide rod is in the vertical direction, and the rotating direction of the guide rod is in the horizontal direction. The clamping arm is screwed on the guide rod. The C-shaped housing is formed with a longitudinal gap for a mounting the clamping arm, and movably restricts the clamping arm in the meantime. The locking mechanism comprises a power source and at least one positioning block which is driven to swing by the power source, each positioning block being used to press against the C-shaped housing to stop it from rotation.

The clamping arm and the C-shaped housing moves in a horizontal direction synchronously along with the rotation of the guide rod under the condition that the horizontal movement of the clamping arm is not restricted, and the clamping arm moves in a vertical direction synchronously along with the rotation of the guide rod under the condition that the positioning block locks and stops the C-shaped housing and the horizontal movement of the clamping arm is restricted, thus handling the goods clamped by the clamping arm.

Furthermore, the positioning block of the locking mechanism can be connected to a driven member, the power source employs a transmission member to drive the driven member which then drives the positioning block to swing. The power source can be a motor, the transmission member can be a worm, and the driven member can be a driven gear which is eccentrically connected with the positioning block.

### BRIEF DESCRIPTION OF THE DRAWINGS

FIG. 1 is a perspective view showing a goods handling device in accordance with a first embodiment of the present invention, wherein the goods handling device has three positioning blocks located in the C-shaped housing;

FIG. 2 is a cross sectional view in accordance with the first embodiment of the present invention showing that the three positioning blocks move away from the C-shaped housing and the clamping arm moves horizontally;

FIG. 3 is a cross sectional view in accordance with the first embodiment of the present invention showing that the three positioning blocks press against the C-shaped housing;

FIG. 4 is an illustrative view in accordance with the first embodiment of the present invention showing that the three positioning blocks press against the C-shaped housing and the clamping arm moves vertically;

FIG. 5 is a perspective view showing a goods handling device in accordance with a second embodiment of the present invention, wherein the goods handling device has two positioning blocks, one of which is located in the C-shaped housing, and the other is located outside the C-shaped housing;

FIG. 6 is a cross sectional view in accordance with the second embodiment of the present invention showing that the two positioning blocks move away from the C-shaped housing and the clamping arm moves horizontally;

FIG. 7 is a cross sectional view in accordance with the second embodiment of the present invention showing that the two positioning blocks press against the C-shaped housing;

FIG. 8 is an illustrative view in accordance with the second embodiment of the present invention showing that the two positioning blocks press against the C-shaped housing and the clamping arm moves vertically.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

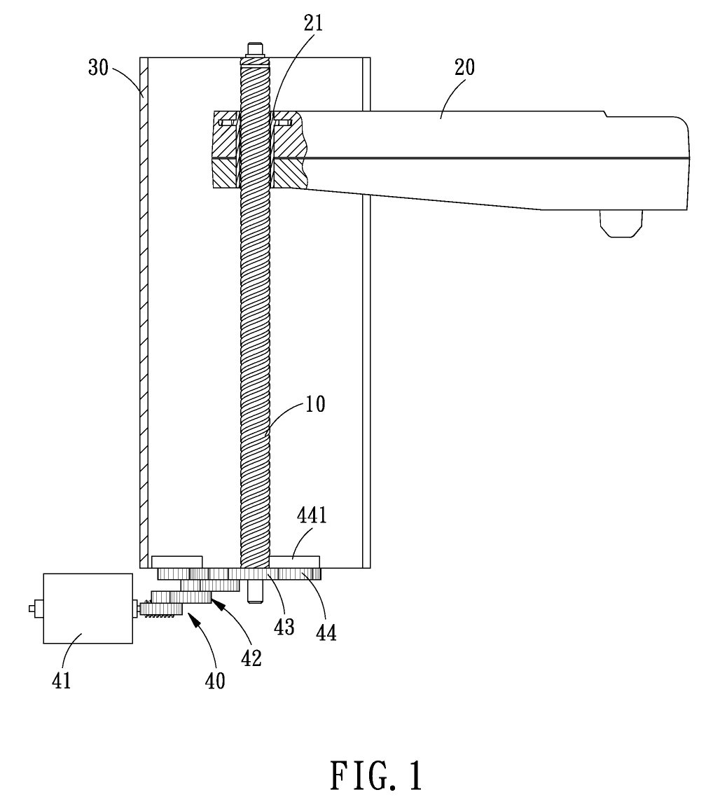

Referring to FIGS. 1-4, a handling device in accordance with the present invention comprises a guide rod 10, a clamping arm 20, a C-shaped housing 30, and a locking mechanism 40.

The axial direction of the guide rod 10 is in the vertical direction, and the rotating direction of the guide rod 10 is in the horizontal direction.

The clamping arm 20 is provided with a nut 21 that has an outer side and an inner side. The outer side of the nut 21 is fixed to the clamping arm 20, and the inner side of the nut 21 is provided with threads and is directly screwed on the guide rod 10.

The C-shaped housing 30 is tubular-shaped and surrounds the guide rod 10 in the horizontal direction, and the axial length of the C-shaped housing 30 corresponds to the length of the guide rod 10. The C-shaped housing 30 movably clamps the clamping arm 20 in the meantime.

The locking mechanism 40 comprises a power source 41, a plurality of middle gears 42, a main gear 43 and three driven members 44. In this embodiment, the power source 41 is a motor, a shaft 411 of the power source 41 is provided with a transmission member 412 which is a worm wheel. Each of the middle gears 42 includes a big toothed wheel 421 and a small toothed wheel 422 which are concentrically assembled together. The middle gears 42 are connected in such a manner that the big toothed wheel 421 of one middle gear 42 is engaged with the small toothed wheel 422 of another middle gear 42, and a big toothed wheel 421 of one of the middle gears 42 is engaged with the transmission member 412 of the power source 41. The main gear 43 and the guide rod 10 are coaxially and movably disposed. A small toothed wheel 422 of one of the middle gears 42 is engaged with the main gear 43. In this embodiment, the transmission member 412 is engaged with the big toothed wheel 421 of a first middle gear 42, and then the small toothed wheel 422 of this first middle gear 42 is engaged with the big toothed wheel 421 of a second middle gear 42, and the small toothed wheel 422 of this second middle gear 42 is engaged with the big toothed wheel 421 of a third middle gear 42, the middle gears 42 are repeatedly engaged in this way, and finally the small toothed wheel 422 of the last middle gear 42 is engaged with the main gear 43. The three driven members 44 are driven gears which are engaged with the main gear 43, respectively, and meanwhile, each of the driven members 44 is eccentrically connected with a positioning block 441 which is located in the C-shaped housing 30.

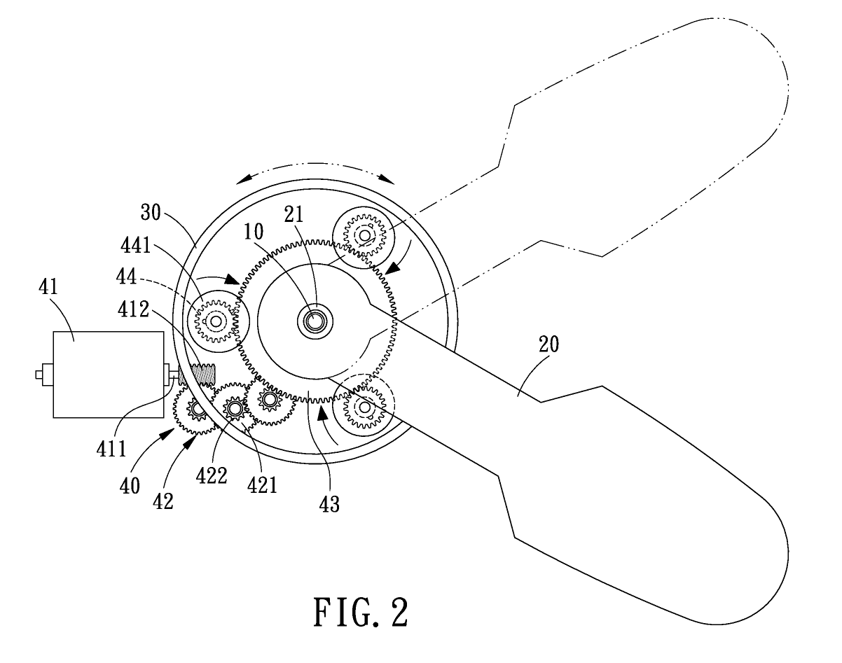

The handling device in accordance with the present invention can achieve an objective of handling goods through the abovementioned structures. As shown in FIG. 2, the locking mechanism 40 employs the power source 41 to rotate the middle gears 42, the main gear 43 and the driven members 44, making the driven members 44 drive the positioning blocks 441 to move away from the C-shaped housing 30. Rotating the guide rod 10 can cause the rotation of the C-shaped housing 30 and horizontal displacement of the clamping arm 20.

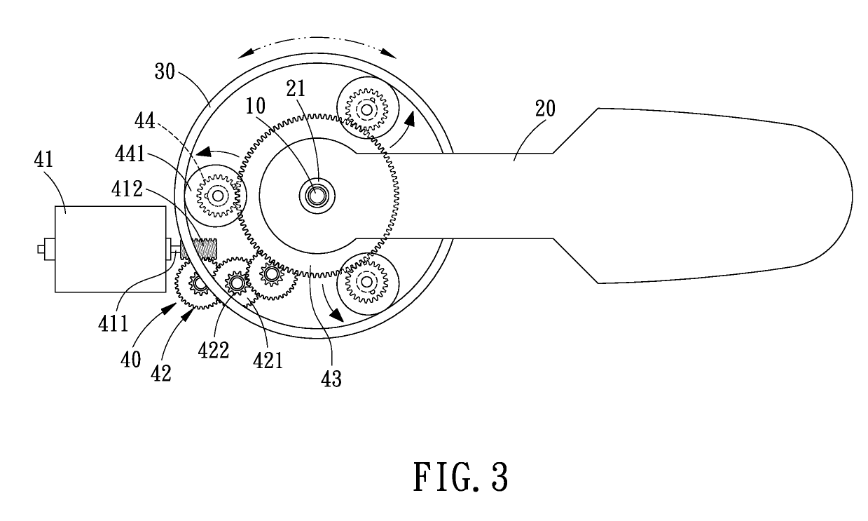

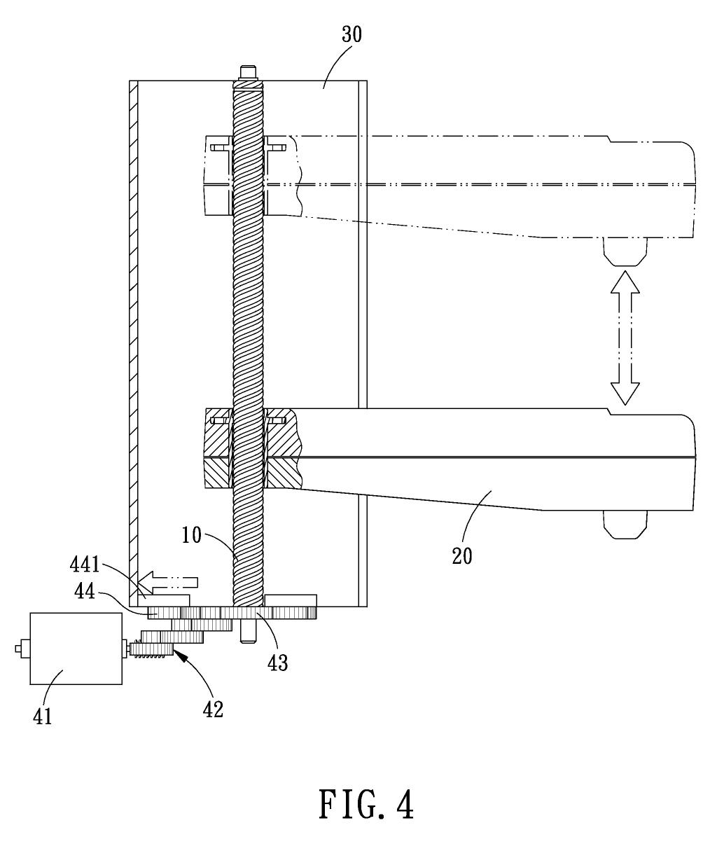

Referring then to FIGS. 3 and 4, the power source 41 drives the driven members 44 to rotate, and the driven members 44 drive the positioning blocks 441 to swing outward from the inner side of the C-shaped housing 30. When the positioning blocks 441 press against the C-shaped housing 30, the C-shaped housing 30 cannot rotate and will stop the horizontal movement of the clamping arm 20, so that the clamping arm 20 cannot rotate. Since the movement in the horizontal direction is restricted, the clamping arm 20 will move up and down in the vertical direction along with the rotation of the guide rod.

When the clamping arm 20 carries goods, the goods can be moved to the destination through the horizontal and the vertical movement of the clamping arm 20; and then goods handling operation is finished by releasing the goods.

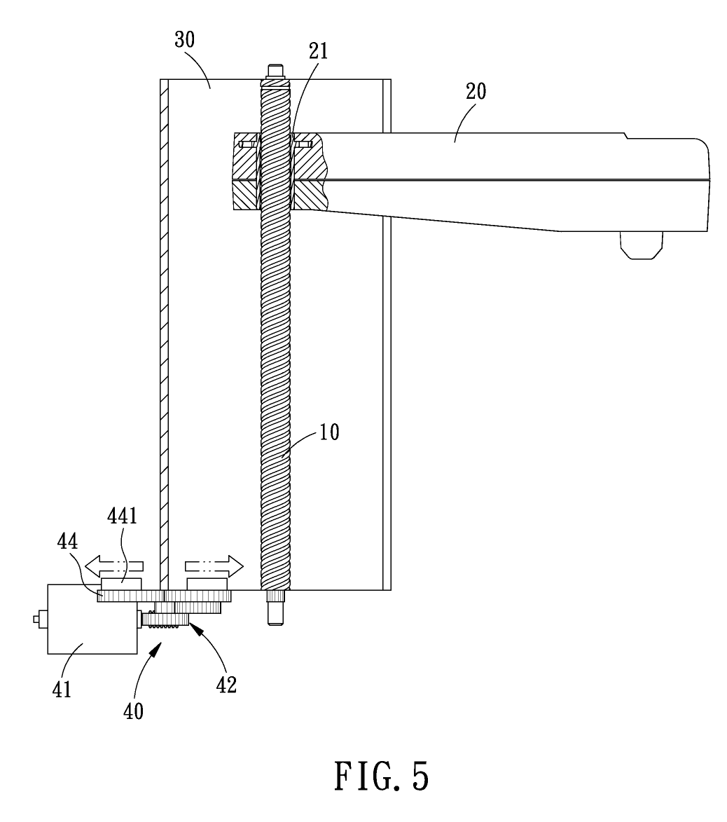

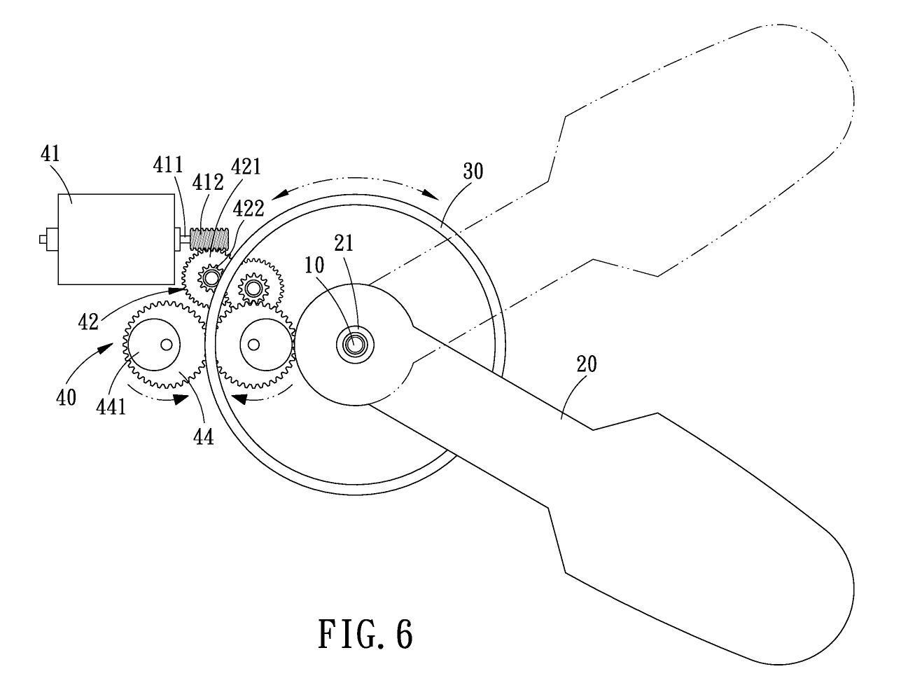

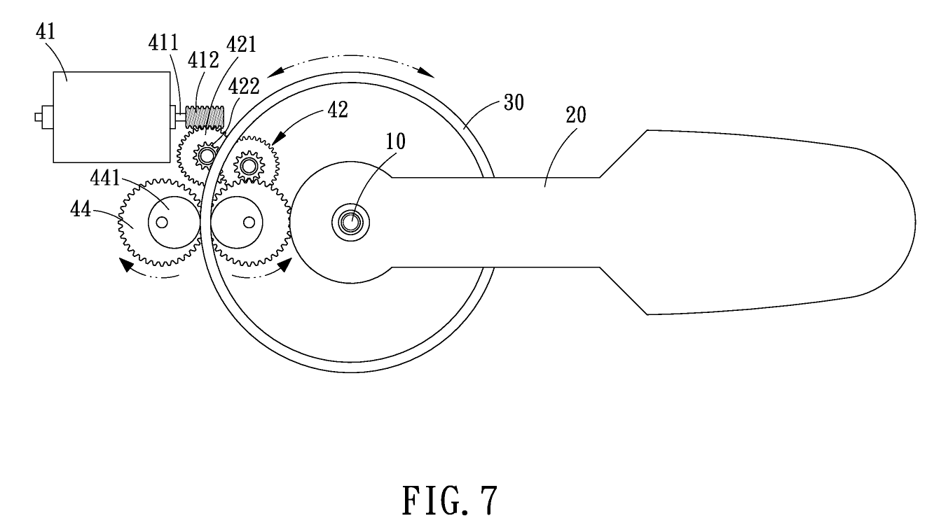

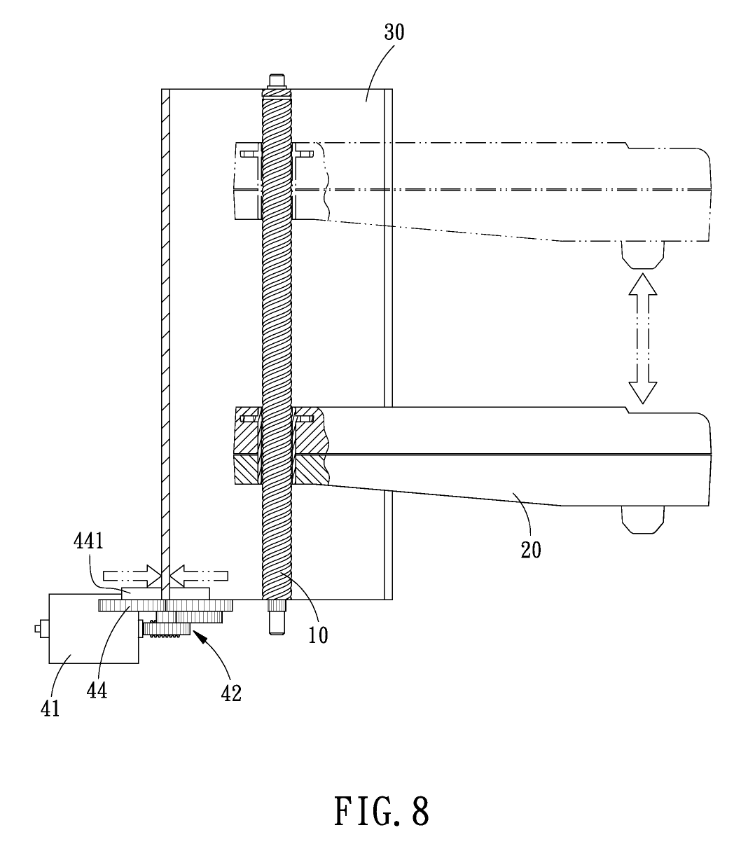

The above embodiment is to stop the rotation of the C-shaped housing 30 by pressing the inner surface of the C-shaped housing 30 with the locking mechanism 40. Besides that, another embodiment of the locking mechanism 40 can also press against the inner and outer surfaces of the C-shaped housing 30 simultaneously to stop the rotation of the C-shaped housing 30, as shown in FIGS. 5-8, the locking mechanism 40 comprises a power source 41, a plurality of middle gears 42 and two driven members 44.

In this embodiment, the power source 41 is a motor, and a shaft 411 of the power source 41 is provided with a transmission member 412 which is a worm wheel. Each of the middle gears 42 includes a big toothed wheel 421 and a small toothed wheel 422 which are concentrically assembled together. The middle gears 42 are connected in such a manner that the big toothed wheel 421 of one middle gear 42 is engaged with the small toothed wheel 422 of another middle gear 42, and a big toothed wheel 421 of one of the middle gears 42 is engaged with the transmission member 412 of the power source 41. The two driven members 44 are driven gears driven by one of the middle gears 42 to rotate. In this embodiment, the transmission member 412 is engaged with the big toothed wheel 421 of a first middle gear 42, and then the small toothed wheel 422 of this first middle gear 42 is engaged with the big toothed wheel 421 of a second middle gear 42, and the small toothed wheel 422 of this second middle gear 42 is engaged with one of the driven members 44. The two driven members 44 are engaged with each other. Each of the driven members 44 is eccentrically connected with a positioning block 441, one of the positioning blocks 441 is located in the C-shaped housing 30, and the other positioning block 441 is located outside the C-shaped housing 30.

The locking mechanism 40 can employ the power source 41 to rotate the middle gears 42 and the driven members 44, making the driven members 44 drive the positioning blocks 441 to swing away from the C-shaped housing 30, so that the clamping arm 20 is allowed to move horizontally. Or, the power source 41 can drive the positioning blocks 441 to simultaneously clamp against the inner and outer side of the C-shaped housing 30. When the positioning blocks 441 press against the C-shaped housing 30, the C-shaped housing 30 cannot rotate and will stop the horizontal movement of the clamping arm 20, so that the clamping arm 20 cannot rotate. Since the movement in the horizontal direction is restricted, the clamping arm 20 will move up and down in the vertical direction along with the rotation of the guide rod.

While we have shown and described various embodiments in accordance with the present invention, it is clear to those skilled in the art that further embodiments may be made without departing from the scope of the present invention.

What is claimed is:

1. A handling device comprising: a guide god, a clamping arm, a C-shaped housing and a locking mechanism; wherein:
the guide rod is provided on its outer surface with an outer thread, an axial direction of the guide rod is in the vertical direction, and a rotating direction of the guide rod is in the horizontal direction, the clamping arm is screwed on the guide rod, the C-shaped housing surrounds the guide rod and is formed with a longitudinal gap, the C-shaped housing is able to rotate when indirectly driven by the clamping arm, the handling device is characterized in that;
the locking mechanism comprises a power source and at least one positioning block which is used to press against the C-shaped housing to stop it from rotation, making the clamping arm and the C-shaped housing move in a horizontal direction synchronously along with the rotation of the guide rod under the condition that the horizontal movement of the clamping arm is not restricted, and making the clamping arm move in the longitudinal gap of the C-shaped housing along with the rotation of the guide rod under the condition that the positioning blocks locks and stops the C-shaped housing and the horizontal movement of the clamping arm is restricted.

2. The handling device as claimed in claim 1, wherein the positioning block of the locking mechanism is connected with a driven member, the power source employs a transmission member to drive the driven member which then drives the positioning block to swing.

3. The handling device as claimed in claim 2, wherein the power source is a motor, the transmission member is a worm wheel, the driven member is a driven gear which is eccentrically connected with the positioning block.

4. The handling device as claimed in claim 1, wherein the clamping arm is provided with a nut, and the clamping arm is screwed on the guide rod through the nut.

5. The handling device as claimed in claim 2, wherein the locking mechanism comprises the power source, the plurality of middle gears, a main gear and three positioning blocks, the power source is a motor, a shaft of the power source is provided with a transmission member in the form of a worm wheel, each of the middle gears includes a big toothed wheel and a small toothed wheel which are concentrically assembled together, the middle gears are connected in such a manner that the big toothed wheel of one middle gear is engaged with the transmission member of the power source, the main gear and the guide rod are coaxially and movably disposed, the small toothed wheel of one of the middle gears is engaged with the main gear, the three driven members are driven gears engaged with the main gear, respectively, each of the driven members is eccentrically connected with a positioning block which is located in the C-shaped housing.

6. The handling device as claimed in claim 5, wherein the transmission member is engaged with the big toothed wheel of a first one of middle gears, and then the small toothed wheel of the first one of the middle gears is engaged with the big toothed wheel of a second one of the middle gears, and the small toothed wheel of the second one of the middle gears is engaged with the big toothed wheel of a third one of the middle gears, the middle gears are repeatedly engaged in this way, and finally the small toothed wheel of a last one of the middle gears is engaged with the main gear.

7. The handling device as claimed in claim 2, wherein the locking mechanism comprises the power source, the plurality of middle gears and two positioning blocks, the power source is a motor, a shaft of the power source is provided with a transmission member in the form of a worm wheel, each of the middle gears includes a big toothed wheel and a small toothed wheel which are concentrically assembled together, the middle gears are connected in such a manner that the big toothed wheel of one middle gear is engaged with the small toothed wheel of another middle gear, and the big toothed wheel of one of the middle gears is engaged with the transmission member of the power source, the two driven members are driven gears driven by one of the middle gears to rotate, each of the driven members is eccentrically connected with a positioning block, one of the positioning blocks is located in the C-shaped housing, and the other positioning block is located outside the C-shaped housing.

8. The handling device as claimed in claim 7, wherein the transmission member is engaged with the big toothed wheel of one of the middle gears, and then the small toothed wheel of the one of middle gears is engaged with the big toothed wheel of the other one of middle gears, and the small toothed wheel of the other one of the middle gears is engaged with one of the driven members, the two driven members are engaged with each other.
